(19) United States
(12) Patent Application Publication
(10) Pub. No.: US 2026/0111860 A1
(43) Pub. Date: Apr. 23, 2026

(54) LOW COMMUNICATION DISTRIBUTED SYSTEMS

(71) Applicant: Visa International Service Association, San Francisco, CA (US)

(72) Inventors: Shivam MOHAN, Uttar Pradesh (IN); Sudharshan Krishnakumar GADDAM, Bengaluru (IN)

(73) Assignee: Visa International Service Association, San Francisco, CA (US)

(21) Appl. No.: 19/154,099

(22) PCT Filed: Feb. 20, 2023
(86) PCT No.: PCT/US2023/062901

§ 371 Date: Aug. 6, 2025

(51) Int. Cl. G06Q 20/02; H04L 12/18

(52) U.S. Cl. CPC G06Q 20/027; H04L 12/1886

(57) ABSTRACT

Systems and methods for low communication distributed systems are disclosed. An example method can comprise receiving, by each node in a distributed system, a correlation function with a plurality of inputs comprising at least an identifier; receiving, at a node of the distributed system, a request comprising the identifier; identifying, by the node, a service node to serve the request based on the correlation function, the identifying comprising determining, by the node, based on a status of the node, the status of other nodes in the distributed system; determining a local state, based on at least one of the status of the node, the status of the other nodes, or a number of nodes in the distributed system; and calculating, based on the local state and the plurality of inputs, a target response that identifies the service node; and processing the request by the service node.

### TECHNICAL FIELD

The disclosure relates to minimizing communications between and within nodes and clusters in distributed cluster systems, which may be used in a variety of networks including payment processing networks and enterprise networks. Namely, the present disclosure provides technologies related to efficient communications via architectures, systems, and methods of low communication distributed systems.

### SUMMARY

In numerous aspects, a method for reducing communications between nodes in a distributed system, the method comprising receiving, by each node in a distributed system, a correlation function with a plurality of inputs comprising at least an identifier; receiving, at a node of the distributed system, a request comprising the identifier; identifying, by the node, a service node to serve the request based on the correlation function, the identifying comprising determining, by the node, based on a status of the node, the status of other nodes in the distributed system; determining a local state, based on at least one of the status of the node, the status of the other nodes, or a number of nodes in the distributed system; and calculating, based on the local state and the plurality of inputs, a target response that identifies the service node; and processing the request by the service node.

In various aspects the method, further comprises transmitting, by the node, the request to the service node.

In various aspects the method, further comprises receiving, by the service node, the request transmitted from the node.

In various aspects the method, further comprises receiving, by the node, a transmitted request from another node in the distributed system for processing, wherein the another node identified the node as the service node; and processing, by the node, the transmitted request.

In various aspects of the method, the node is the service node.

In various aspects of the method, the correlation function is configured to generate a mutually exclusive output based on the plurality of inputs.

In various aspects of the method, the correlation function produces a mutually exclusive output to allow each node in the distributed system of nodes to determine a service node of the request.

In various aspects of the method, the determining of a local state is based on the status of the node, the status of the other nodes, and the number of nodes in the distributed system.

In numerous aspects, a real-time financial transaction interface and processing system is disclosed; wherein the system comprises a distributed cluster, connected to a plurality of payment interfaces, the distributed cluster comprising a plurality of node groups to process transaction requests, the plurality of node groups each comprising at least one node; a transaction gateway capable of interfacing with a plurality of client devices, configured to receive a transaction request from a client device; and direct the transaction request to a payment interface of the plurality of payment interfaces; the plurality of payment interfaces connected to the transaction gateway, wherein the payment interface of the plurality of payment interfaces is configured to receive the transaction request from the transaction gateway; identify a node group of the plurality of node groups to serve the transaction request based on a correlation function; and transmit the transaction request to a group designate node of the node group; the group designate node configured to identify at least one service node in the node group to serve the transaction request based on a correlation function; and transmit the transaction request to the at least one service node to process the transaction request.

In various aspects, the at least one service node stores a result of a processing of the transaction request in a local storage.

In various aspects, the stored result is transmitted into a data storage warehouse.

In various aspects, the at least one service node is configured to: receive a substitute transaction request for a processed transaction stored in its local storage; and process the substitute transaction request to alter the processed transaction.

In various aspects, the transaction gateway is further configured to select the payment interface based on at least one of its latency, network traffic status, or geographical proximity.

In various aspects, the identifying of the node group by the payment interface comprises determine, by the payment interface, based on a status of the payment interface, the status of the plurality of node groups in the distributed cluster; determine a local state, based on at least one of the status of the payment interface, the status of the plurality of node groups, or a number of nodes in the distributed cluster, or a total number of nodes in the real-time financial transaction interface and processing system; and calculate, based on the local state and a plurality of inputs, a target response that identifies at least one of the plurality of node groups.

In various aspects, each node group of the plurality of node groups comprises an exposed end point, the exposed end point configured to receive the transaction request to be processed by the at least one node in the node group; and undertake the identifying of the at least one service node for the node group.

In various aspects, the identifying of the at least one service node by the group designate node comprises determine, based on a status of the group designate node, the status of other nodes in the node group; determine a local state, based on at least one of the status of the group designate node, the status of the other nodes, a number of nodes in the node group, a total number of nodes in the distributed cluster, or a total number of nodes in the real-time financial transaction interface and processing system; and calculate, based on the local state and a plurality of inputs, a target response that identifies the at least one service node.

In various aspects, the transaction request is at least one of a payment request, or a payment-reversal request.

In numerous aspects, a non-transitory machine readable medium storing code, which when executed by a processor is configured to receive, a correlation function with a plurality of inputs comprising at least an identifier; receive, a request comprising the identifier; identify, a service node to serve the request based on the correlation function, the identifying comprising determine, based on a status of one node, the status of other nodes in a distributed system; determine a local state, based on at least one of the status of the node, the status of the other nodes, or a number of nodes in the distributed system; and calculate, based on the local state and the plurality of inputs, a target response that identifies the service node.

In various aspects the non-transitory machine readable medium storing code when executed by a processor is further configured to transmit the request to the service node.

In various aspects the non-transitory machine readable medium the determining of the local state is based on at least one of the status of the node, the status of the other nodes, or a number of nodes in a distributed system.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a traditional distributed setup in a cluster, where nodes communicating with each other generate a large number of messages sent and received.

FIG. 2 illustrates an alternative traditional cluster configuration aimed at reducing communications between nodes by utilizing a broadcasting controller node.

FIG. 3 illustrates a simplified aspect of nodes programmed to generate mutually exclusive, idempotent outputs to queries based on a correlation function, according to at least one aspect of the present disclosure.

FIG. 4 illustrates a low communication node cluster architecture, according to at least one aspect of the present disclosure.

FIG. 5A-5B illustrate subsequent requests being handled by a low communication node cluster at different time periods, according to at least one aspect of the present disclosure.

FIG. 6 illustrates a flow diagram of a method to handle requests by a low communication node cluster, according to at least one aspect of the present disclosure.

FIG. 7 illustrates a flow diagram of one aspect of a method to identify, via a correlation function, a service node to serve a request, according to at least one aspect of the present disclosure.

FIG. 8A-8B illustrate subsequent transaction requests being handled by a transaction processing and interfacing system running a low communication node cluster, according to at least one aspect of the present disclosure.

FIG. 9 illustrates a node that may be used in a low communication node cluster in a distributed system, according to at least one aspect of the present disclosure.

FIG. 10 illustrates a block diagram of a computer apparatus, according to at least aspect of the present disclosure.

FIG. 11 illustrates a diagrammatic representation of an example system that includes a host machine within which a set of instructions to perform any one or more of the methodologies discussed herein may be executed.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

The terms “client”, “client device”, and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system. furthermore, the terms “client” and “client device” may refer to one or more client-side devices or systems (e.g., remote from a transaction service provider) used to initiate or facilitate a transaction (e.g., a payment transaction). Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the terms “communication”, “communicate”, “transmission” and “transmit” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

The terms “gateway”, “transaction gateway”, or “payment gateway” may be a specialized processor that serves the unique needs of a merchant or specific merchant vertical group. A gateway may connect a merchant to payment or transaction processing networks, acquirer networks, or issuer networks. For example eCommerce gateways may allow online merchants to connect to proprietary formats and systems of acquiring processors. Because of online fraud risks, a gateway may also provide risk management capabilities and anti-fraud measures. A gateway in any of its formats may provide card acquiring services to a merchant.

An “interface”, “payment interface”, or “transaction interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some embodiments or aspects, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system.

Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

A “substitute” transaction may be any transaction that is associated with an original transaction and that takes place after the original transaction, including repeat, refunds, reversals or exceptions (chargebacks, re-presentments, etc.).

As used herein, the term “system” may refer to one or more computing devices or combinations of computing devices (e.g., processors, servers, client devices, software applications, components of such, and/or the like).

A “transaction amount” may be the price assessed to the consumer for the transaction. The transaction amount condition may be a threshold value (e.g., all transactions for an amount exceeding $100) or a range (e.g., all transactions in the range of $25-$50). For example, a user may wish to use a first routing priority list for a transaction for an amount in the range of $0.01-$100 and a second routing priority list for a transaction for an amount exceeding $100.

The term “transaction data” may include any data associated with one or more transactions. In some embodiments or aspects, the transaction data may merely include an account identifier (e.g., a PAN) or payment token. Alternatively, in other embodiments or aspects, the transaction data may include any information generated, stored, or associated with a merchant, consumer, account, or any other related information to a transaction. For example, transaction data may include data in an authorization request message that is generated in response to a payment transaction being initiated by a consumer with a merchant. Alternatively, transaction data may include information associated with one or more transactions that have been previously processed and the transaction information has been stored on a merchant database or other merchant computer. The transaction data may include an account identifier associated with the payment instrument used to initiate the transaction, consumer personal information, products or services purchased, or any other information that may be relevant or suitable for transaction processing. Additionally, the transaction information may include a payment token or other tokenized or masked account identifier substitute that may be used to complete a transaction and protect the underlying account information of the consumer.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

Distributed systems are commonly utilized to solve various large-scale problems in systems and architectures that are used to provide services to large scale networks and enterprises. Distributed systems allow individual nodes to work together in clusters, from various geographic locations, and with modularity, to process extremely large amounts of data and produce outcomes to very complex and computationally heavy problems. Each node is able to process a part of a problem, or a specific dataset, while the combination of nodes together are able to generate a full result, that would have otherwise been too difficult and time-consuming to practically be performed by one node. Another advantage that these distributed systems provide is the lack of a single point of failure, where one node may take over another node's tasks if the prior node has failed or is offline or inactive.

However, in this technological space, efficient communications between and within nodes and/or clusters in a distributed system is an ongoing issue. Various communication challenges are inherently coupled to the architecture of distributed systems, these challenges include fault tolerance, high availability, consistency, and efficiency of communication and coordination between nodes.

The communication patterns in a distributed algorithm, system or cluster can generally be classified into 3 broad categories, the first may be described as communications of state, or state communications, which describe or communicate the state between all participating nodes in the distributed setup to reach a consensus. The second may be described as the communication of data which describes the transfer of actual data, for example, the copying or moving of files between nodes. Finally the third type of communication may describe communication of status that describes results of the data transfer that occurred and actions taken or to be taken based on that result.

Two major problems related to communications arise in distributed systems, the first is that the need for coordination and communications between nodes can hinder scalability of a cluster of nodes. This limitation hits at the core of distributed computing, which is based on the principle of horizontal scaling, which suggests that to improve performance we can add compute capacity to a distributed setup, however as we increase the number of nodes in a distributed system, we also incur high cost of network communication, which ultimately becomes the limiting factor of the number of nodes we can have in distributed system.

This is because as the number of nodes increase, to increase the power and size of a cluster to solve ever larger or more complex problems, the larger the number of communications between nodes become. Because the number of nodes increase, so does the need for coordination also increase, requiring increased communications, generally in the form of a higher number of messages travelling between the higher number of nodes. This need for more coordination and communication is a limiting factor on how large a distributed cluster can be expanded where diminishing returns of larger cluster sizes act as a ceiling for the size of the system.

The second major problem that arises in distributed systems, is that in most instances it is not feasible to have nodes communicating at a large scale across disparate geographical locations. In most current systems, nodes are generally housed or co-located together in the same physical location, generally in the form of a datacenter. This is because, the overhead costs of communication are already one of the most computationally expensive operations in a cluster, and the further nodes are from each other the more resource intensive it is to send and receive messages between the nodes and within the cluster, and the slower the transmission or communication between the nodes become. Therefore, network latency usually pushes distributed systems to have all nodes of a system being co-located to improve latency and reduce computational costs by reducing geographical distance. This push towards co-locating nodes removes one of the advantages of a distributed system, which is to have nodes located at geographically separate locations, hindering any decentralization benefits that could be accrued by a truly geographically distributed system.

The present disclosure provides techniques, systems, and methods to reduce the number of interactions required by distributed systems to reduce computational costs introduced by communications, and remove the lag introduced by network communications delays and making communications/coordination in distributed systems more efficient. The present disclosure reduces the communication overhead of distributed systems by providing each node with the ability to determine the state of every other participating node in a cluster via a stateless idempotent injective function, therefore precluding the need to transmit messages/communications to and from other nodes. This reduces the communication overhead belonging to the communications of state. Since the state can be calculated by all the participating nodes deterministically without the need of any explicit sharing of information repeatedly. The techniques described herein therefore not only reduce the communications and its associated computational and network costs in a system, but allow nodes to be in geographically independent and separate locations, since they do not have to undertake various communications that they ordinarily would rely on.

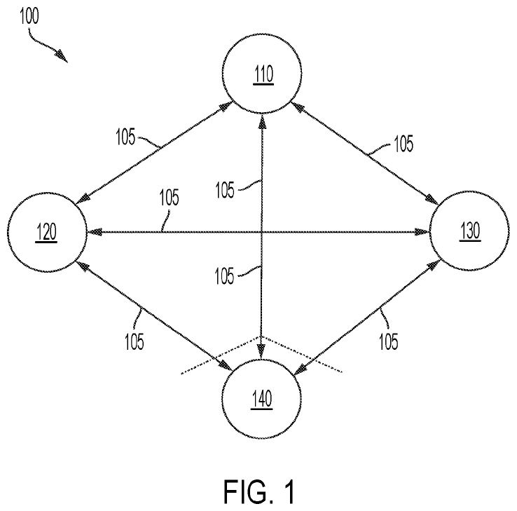

FIG. 1 illustrates a traditional distributed setup in a cluster, where nodes communicating with each other generate a large number of messages sent and received. Cluster 100 is how many traditional distributed systems currently function, with node 140 broadcasting a message 105 to each and every node in cluster 100 and then receives messages 105 back acknowledging receipt of the message. In order to ensure that the nodes know each other's states, each node not only responds to node 140, but sends an acknowledgement message 105 to all other nodes 110-140, to inform them of its current state, for example of having successfully received the message from node 140. Therefore in this cluster 100, if two messages go between each node, then the true cost in terms of the total number of messages from one broadcast message being sent send is 2*number of nodes+(broadcast message 105+acknowledgement message 105)*number of nodes. Thus, in this example, the total true cost of one broadcast message being sent is 12 messages within cluster 100.

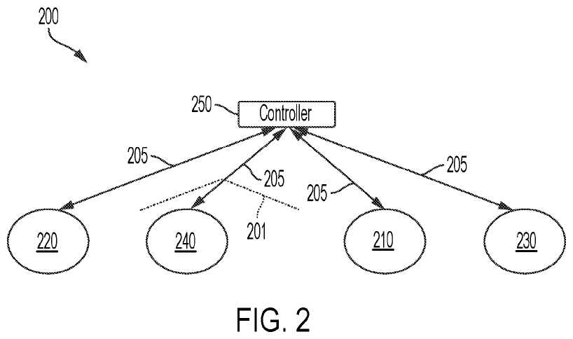

FIG. 2 illustrates an alternative traditional cluster configuration aimed at reducing communications between nodes by utilizing a broadcasting controller node. With reference primarily to FIG. 2, together with FIG. 1, distributed system or cluster 200 provides a traditional alternative to the architecture of cluster 100, FIG. 1. In this architecture implemented by cluster 200, the responsibility of broadcasting a message is delegated to only one node, the controller 250. Therefore in this aspect, node 240 may initiate a request 201, and must transmit it as a message 205 to controller 250, where controller 250 broadcasts the message 205 to any of, or all nodes 210-240 in the cluster. Controller 250 also receives confirmation messages 205 back from the nodes 210-240 it broadcasts the message 205 to. Controller 250 may also transmit a confirmation message 205 to node 240 confirming receipt of the request 201. This means that in this configuration, the load on node 240 is much lower, since it does not have to broadcast its messages across the cluster, but the load on controller 250 is much higher since it must be the sole node in charge of broadcasting messages. Furthermore, in this configuration, the other messages only send messages 205 confirming receipt or state back to controller 250 and not to other nodes 210-240.

With continued reference primarily to FIG. 2, together with FIG. 1, while this configuration is a relative improvement in terms of the total number of messages sent within a system or cluster 200, by reducing this number, compared to cluster 100, FIG. 1, the system 200 has its drawbacks. The number of total messages 205 are reduced because each of the nodes 210-240 only directly communicate with controller 250, this controller 250, therefore is a single point of failure in the distributed system or cluster 200. Distributed system architectures are deployed by networks, and are effective, because they do not rely on a single node that may act as a single point of failure. The single point of failure introduced by controller 250 provides a significant disadvantage to cluster 200, which makes it much less reliable than cluster 100, FIG. 1. If controller 250 is inactive or goes down for any reason, then the whole cluster 200 will also go down or be disabled. A single point of failure is considered to be a design flaw to be avoided in distributed system setups.

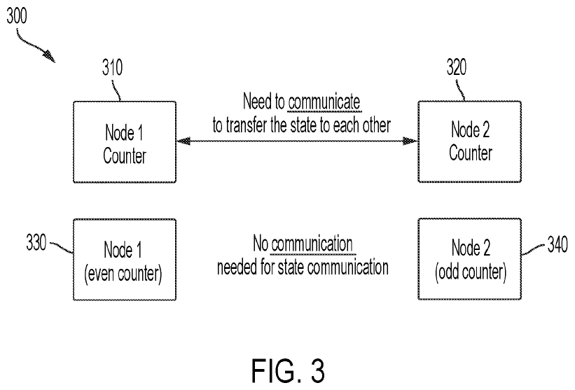

FIG. 3 illustrates a simplified aspect of nodes programmed to generate mutually exclusive, idempotent outputs to queries based on a correlation function. The correlation function is loaded onto each node, reducing the need for communications between them, according to at least one aspect of the present disclosure. In this example, nodes 310 and 320 are standard nodes without a correlation function. Nodes 310, 320 need to communicate with each other via transmitted messages for example to transfer knowledge about the state of each node to the other node. In contrast, node 330 and node 340 have received a correlation function, and have loaded or installed the correlation function. Node 330 has a correlation function that runs an even counter, while node 340 has the same correlation function but it runs an odd counter.

The correlation function may be transmitted to each node, by a controller or function generator node (not shown) for example. Once nodes 330, 340 receive the functions, they can then load and/or install the function locally, for example in local storage. Based on parameters received with the function, the state of the node, or a request to execute the functions, the function on each node 330, 340 executes an even or odd counter, at a certain frequency. In one example each counter executed adds +1 per second. In another example, a starting point is set by each function on each node, a node running an odd counter may begin at 5, and a node running an even counter may begin at 6. Other examples may rely on the state of the nodes 330, 340 to determine the start count, the frequency of counts, and whether each node is an odd or even counter.

In an example aspect, node 330 may be at count ‘10’ while node 340 would be at ‘11’ (or ‘9’ depending on which node is configured to be ahead). Therefore based on their own internal states, each of node 330 and node 340 is able to determine the count or state of the other node 330, 340. For example node 330 knows that when it is at ‘10’ that node 340's state is ‘11’. This is because node 330 knows that they both have a starting point and a similar frequency of counts, so if it currently is at ‘10’, then based on its internal state and parameters of the function such as “count frequency”, it can determine node 340 is at ‘11’. The parameters and states that node 330 can use to make its determination can include knowledge that node 340 is an even counter, and that even counters begin at a certain numbers, in addition to count frequencies of node 340.

Therefore nodes 330, 340 do not need to communicate with each other to inform or share state knowledge about themselves with the other. Each of these nodes 330, 340 is able to determine the state of the other node 330, 340 based on its own state (and in some aspects the local system state) via the correlation function. This can be extended to multiple nodes in a cluster, with a function being able to consider a local state of the node, for example the even or odd counter to determine the states of other nodes in the system. The function will also use a request identifier to identifier the function, and the parameters that should be used in the instance a request or trigger occurs to run the function. Various types of functions may be implemented in distributed systems to execute functionalities and solve complex problems of various domain spaces and applications.

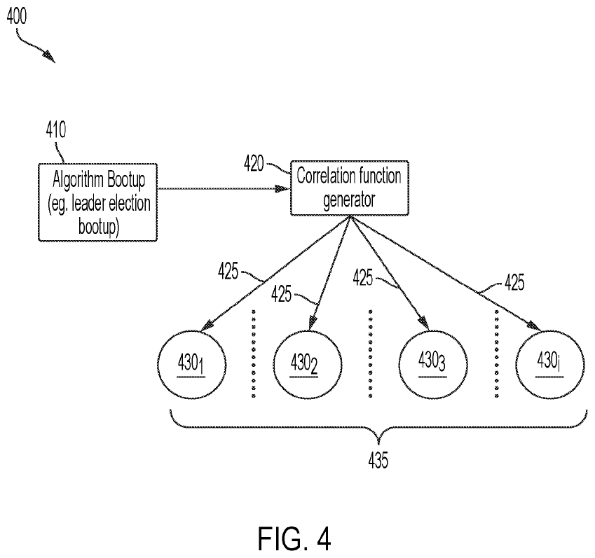

FIG. 4 illustrates a low communication node cluster architecture, according to at least one aspect of the present disclosure. With reference primarily to FIG. 4 together with FIG. 3, the technologies disclosed herein may include system or system architecture 400, which can include a correlation function generator 420. In distributed systems, a cluster comprises multiple individual nodes, which are responsible for working on a small sub-set of an actual problem or computation (for example, creating aggregation on top of a dataset) and these individual nodes return the result of that sub-set. The result of that sub-set may then collated for all the participating nodes in the cluster and combined to form the final answer, result, or outcome.

Generator 420 may be created, activated, or permitted to run upon bootup of system 400, or executed by an algorithm bootup 410. Cluster 435 can be comprised of nodes 430₁₋ᵢ. In some aspects, cluster 435 may also include generator node 420. Algorithm bootup 410, can be a software module, a hardware module, an application, an instruction, applet, virtual machine, or a node, and it may be part of cluster 435 or may be separate to it, depending on the aspect and configuration of cluster 435. Generally, when cluster 435 comes into existence, or is generated, a correlation function is transmitted/transferred 425 by generator 420 to each of the different nodes 430₁₋ᵢ in cluster 435. The correlation function in numerous aspects is a stateless idempotent injective function. In some aspects, generator 420, only after being activated or executed, can transmit 425 correlation functions to each of nodes 430₁₋ᵢ. In various aspects, each node will be assigned an identifier ‘s’ which will be from a set of predefined numbers ‘S’.

Each of nodes 430₁₋ᵢ may then install or load the correlation function. The correlation function has specific properties, which will cause each individual node 430₁₋ᵢ to find the state of each other individual node 430₁₋ᵢ by executing the function with parameters/inputs. In some aspects, the correlation function may be executed immediately upon loading or install, and in alternative aspects, the function may be executed upon receipt of a request or instruction from a different node or request source, or by another system event or trigger.

In numerous aspects, the function will be a special correlation function which when given correct inputs will have the capability to generate mutually exclusive, idempotent outputs. In various aspects, the output can be a decision or a selection of service node(s) that will serve or process the request. The output of function will always be correlated with certain hidden (to the nodes) relations or parameters, which will allow all the nodes 430₁₋ᵢ to independently determine the state of every other node 430₁₋ᵢ, which will be guaranteed to be consistent. In several aspects the function can be in the form F(local_state, request_id, . . . , . . . )=target_response. Where target_response⊂{Fixed set of states}. The target_response selected by node 430₁₋ᵢ running the correlation function can be dynamic, for example can be based on or consider a dynamic factor such as network traffic, or a load factor, which is stored as part of the local state.

The parameter intended to calculate a local state, for example local_state, can determine the local state of cluster 435. The local state of cluster 435 may be made up of one or more parameters as well, including and not limited to the number of nodes 430₁₋ᵢ participating in cluster 435. The number of nodes 430₁₋ᵢ becomes the result set within which the target response of the function should lie, since it determines the set from which a service node to process a request can be selected.

Another parameter that can be part of determining the local state of a cluster is the status of one or more nodes 430₁₋ᵢ in cluster 435. The status of node(s) 430₁₋ᵢ may determine whether node(s) 430₁₋ᵢ are ready to accept requests or not. This is to avoid redirection of requests to node(s) 430₁₋ᵢ which are not accepting requests and/or are no longer part of cluster 435.

In several aspects, when decisions need to be made that require participation of all nodes 430₁₋ᵢ, a trigger event (that may be defined by the correlation function), will cause all the nodes 430₁₋ᵢ (that possess the correlation function) to calculate the correlation function value for themselves as well as for other nodes 430₁₋ᵢ. Based on predefined sets of rules, nodes 430₁₋ᵢ will compare their calculation against those rules to reach to a deterministic, unanimous decision, for example to determine whether to process a request, transmit the request to another node 430₁₋ᵢ, or to do nothing. Each node 430₁₋ᵢ may receive multiple correlation functions, each of which may be related to the same or different programs or applications. Therefore in architecture 400, nodes 430₁₋ᵢ do not have to communicate with each other or transmit messages to each other to inform one another of each other's states, since each node may discover the state of every other node and/or the local state of the cluster by using the correlation function.

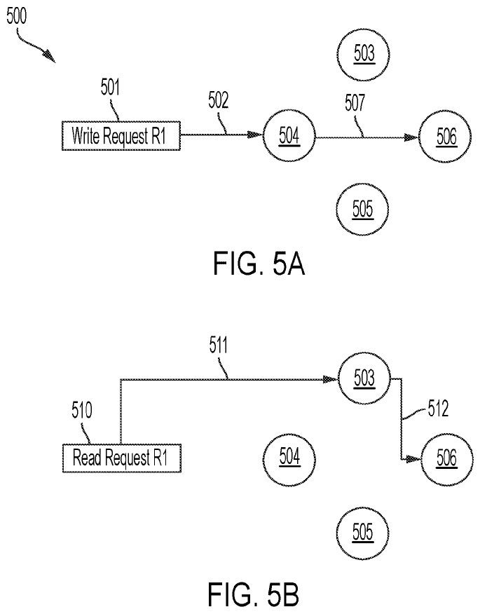

FIG. 5A-5B illustrate subsequent requests being handled by a low communication node cluster at different time periods, according to at least one aspect of the present disclosure. FIG. 5A presents the state of cluster 500 at time=t. FIG. 5B presents the state of cluster 500 at time=t+x. With reference to FIG. 5A, together with FIG. 4, at time t, a request 501, which could include any type of request, data transmission, or query, including a write request for example, is transmitted 502 to a receiving node 504 (“receiving node” is used herein to refer to node(s) that receive a request). Request 501 may be generated from a client, a device, a gateway, a user device, a node, or any other source inside or outside the cluster. Request 501 will comprise certain attributes, such as parameters, metadata, or data elements. These attributes may identify and provide information about, or related to the request, including what the request entails, related correlation function(s) to the request and any specific applications connected to the request.

The nodes in cluster 500, have all already received correlation function(s), which may have for example been received 425, FIG. 4, from correlation function generator 420, FIG. 4. Therefore when receiving node 504 receives the transmitted request 501, and identifies the request 501 as requiring the execution of a specific correlation function that it has already received, loaded, and/or installed then it can use the correlation function that is present on node 504 to run one iteration of the function to identify which node (dependent on the request attributes) should serve request 501 (the term “service node” is used herein to refer to nodes that are selected, or designated by a correlation function, or by a receiving node executing a correlation function to service a request, such as request 501). In numerous aspects, once the correlation function is run on node 504, and node 504 determines a particular node is to serve request 501, based on the correlation function, for example it determines node 506 is the service node, it may then transmit 507 the request 501 to node 506, so that node 506 may process or serve request 501.

Turning to FIG. 5B which is a continuation of FIG. 5A and at time=t+x, i.e., at a point in the future of FIG. 5A, then a new request 510, which may for example be a read request, is transmitted 511 to a receiving node, that may be the same receiving node 504 as in FIG. 5A or be a different receiving node for example node 503. Receiving node 503, then uses a correlation function (which generally is the same function as used in FIG. 5A, but depending different correlation functions could be deployed to determine node states for different tasks, for example one function for a write request and another for a read request) to determine which node served request 501 at time=t. Node 503 may receive a read request 510, for an outcome or result of node 506 serving write request 501, FIG. 5A. In traditional architectures, a message would have to be transmitted by node 503, for example a broadcast message to all the other nodes in cluster 500, to determine which node served the initial write request 501. In some of these traditional systems, the system would have to maintain a cache or some memory or storage, at a central entity which would introduce a single point of failure, for example similar to controller 250, FIG. 2. A traditional system may also have to perform a broadcast asking each node to reply if they have served the earlier request 501, performing a broadcast would result in a total of n messages (n−1 broadcast+1 reply).

In contrast to traditional architectures, the architecture of cluster 500 allows it to avoid sending messages to communicate states between nodes. In this example, communication is cut down by a factor of n, where n is a number of nodes participating in the cluster 500. Additionally, the architecture of cluster 500 demonstrates that the present disclosure overcomes one of the primary constrains of scaling distributed systems, which is having to co-locate all the hardware nodes in the same data centers to be geographically proximate to each other. Because the presented architecture of FIG. 4, and 5A-5B significantly reduces the communication overhead, spreading the clusters in large geographically separated datacenters will no longer result in prohibitively high latencies or computing expense.

In cluster 500, due to the correlation function, node 503 does not need to send any messages to any other node in cluster 500, but determines based on a correlation function, by using parameters known to node 503, including the local state of cluster 500, the state of the cluster 500 at time=t, and determines which node served request 501. Because the correlation function is an idempotent injunctive function it will reach the same result as node 504 did at time=t, when it executed the same correlation function. Node 503 at time=t+x is able to determine that node 506 served the original write request 501, and therefore possesses the data to serve the subsequent and related read request 510. This allows node 503 to transmit 512 request 510 to node 506 to serve it. This methodology allows the nodes to therefore determine the states of each node in the cluster based on the same function, to reach the same outcomes.

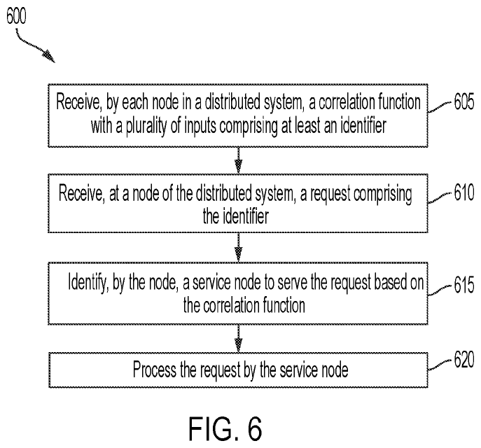

FIG. 6 illustrates a flow diagram of one aspect of a method to handle requests by a low communication node cluster, according to at least one aspect of the present disclosure. Method 600 comprises receiving 605 by each node in a distributed system, for example nodes 430₁-430ᵢ in cluster architecture 400, a correlation function with a plurality of inputs comprising at least an identifier. The correlation function may be transmitted by a controller, node, correlation function generator 420, FIG. 4 or another source. Receiving 605 allows, or causes each receiving node to deploy, install, or load the function so that it may be executed when necessary. In several aspects, the correlation function is configured to generate a mutually exclusive output based on the plurality of inputs. In various aspects this mutually exclusive output allows each node to determine a service node to process or service the request. The plurality of inputs, including the identifier, transmitted with the correlation function may include various information, which may include and not limited to related applications, instructions when to use the function, tagged metadata, parameters, identifiers that may be triggered when received with instructions, and the like.

Method 600 also comprises receiving 610, at a node of the distributed system, a request comprising the identifier. This may be a request similar to requests 501, 510, FIG. 5A-5B. The request comprises the identifier that is associated with the correlation function and received 605 with the function by the plurality of nodes. Once a request with an identifier that is known to the nodes is received, the receiving node(s) may then execute the associated function with the parameters known to it. In various instances, this execution of the associated correlation function is undertaken to identify 615, by the node, a service node to serve the request based on the correlation function. In several aspects, a trigger event may trigger an execution of a correlation function in multiple, or all the nodes in the cluster. For example, a trigger event, such as a request, transmission, message, or any other trigger, may require all nodes to each determine or calculate a portion of a problem, each portion or calculation based and determined by the correlation function.

The correlation function may identify service node(s), or it may be designed to undertake, complete, or calculate other functions. The correlation function may for example allow each node to calculate what its role is, when a cluster is computing a multi-nodal problem. The correlation function may be configured to carry out a number of functionalities depending on the design of the function, the application that it relates to, what the cluster is designed or configured to do, and the like. Method 600 may also include processing 620 the request by the service node. In several aspects, this processing is done after transmission of the request by the receiving node to the service node after it identifies the service node. In other aspects, the receiving node may determine that it itself is the service node, and process the request locally.

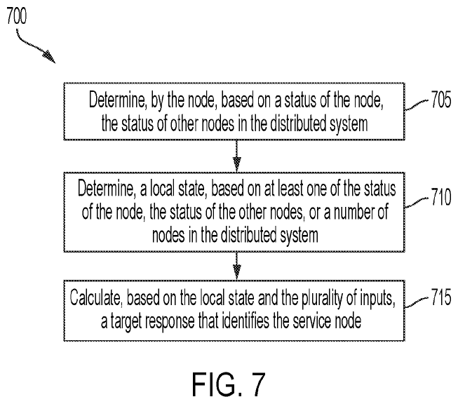

FIG. 7 illustrates a flow diagram of one aspect of a method to identify, via a correlation function, a service node to serve a request, according to at least one aspect of the present disclosure. With reference to FIG. 7 together with FIG. 6, method 700 may describe one aspect of how to undertake identifying 615, FIG. 6 of a service node, by a node receiving a request. Method 700 may commence by determining 705 by the node, based on a status of the node, the status of other nodes in the distributed system. In several aspects, the node is the receiving node(s) that execute the correlation function after receiving a request, for example node 504, FIG. 5A.

Once the status of the other nodes is determined 705, the receiving node(s) determine 710, a local state, based on at least one of the status of the node, the status of the other nodes, or a number of nodes in the distributed system. The local state describes the state of the system, and may include parameters such as the total number of nodes, the number of active nodes, the status of each node in the system, and the like, as described in further detail in FIG. 3. After determining the status of the node, the status of the other nodes, and the local state, the receiving node may calculate 715, based on the local state and the plurality of inputs, a target response that identifies the service node. The calculation 715 may be done as part or exclusively by a correlation function loaded in the nodes. The plurality of inputs may include parameters that include an identifier of the function and/or request, as well as other programmable parameters that may vary, based on the correlation function and what it is designed to determine or do.

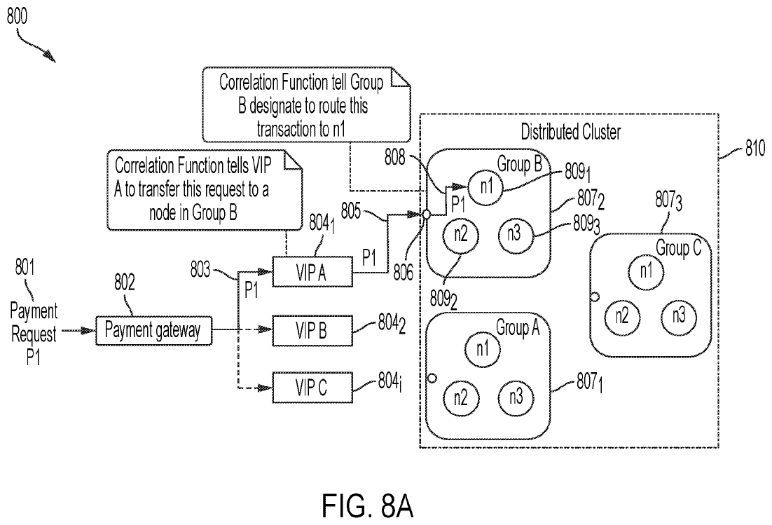

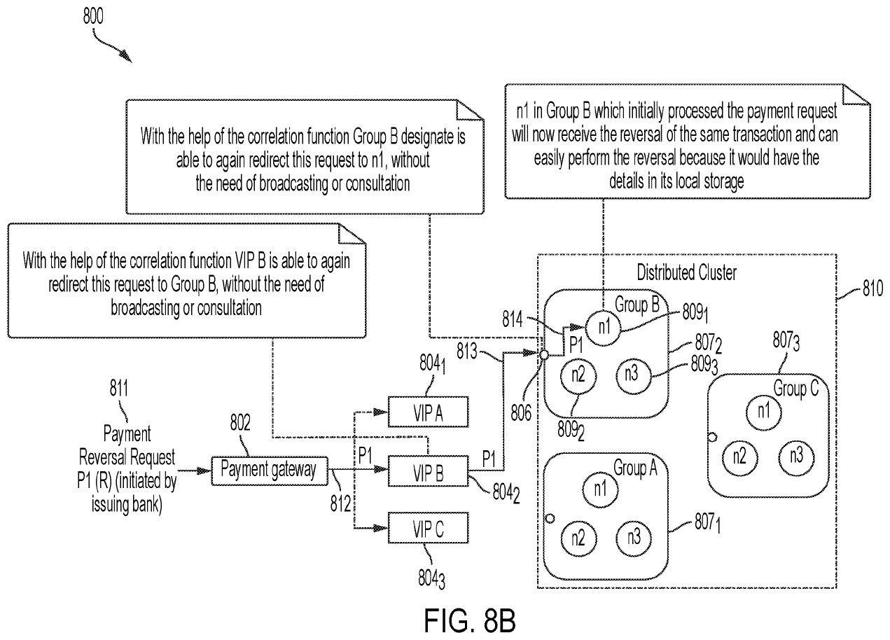

FIG. 8A-8B illustrate subsequent transaction requests being handled by a transaction processing and interfacing system running a low communication node cluster, according to at least one aspect of the present disclosure. FIG. 8A describes a transaction or payment transaction being undertaken by a system 800 that may be owned by an issuer or a payment acquirer, or other payment facilitator or processing service. Similar to FIG. 5A-5B, in various instances FIG. 8A describes transaction processing occurring at time=t, while FIG. 8B described a substitute transaction process occurring at time=t+x. System 800 includes a distributed cluster 801. Distributed cluster 810 can be similar in its architecture and functionality as cluster 400, FIG. 4, or cluster 500, FIG. 5A-5B. System 800 may comprise a payment network or payment processing network, an issuer network, an acquirer network, or any other transaction processing network that forms at least a part of a transaction process.

A financial transaction request 801, for example such as a payment request, can be generated by a client through a transaction or payment gateway 802 capable of interfacing with a plurality of client devices. System 800 may comprise various payment interfaces, or payment interface nodes 804₁₋ᵢ. Distributed cluster 810 can be connected to a plurality of transaction interfaces 804₁₋ᵢ, the distributed cluster comprising a plurality of node groups 807₁₋ᵢ to process transaction requests, the plurality of node groups 807₁₋ᵢ each comprising at least one node.

Gateway 802 may receive a transaction request from a client device; and direct the transaction request to a transaction interface of the plurality of interfaces 804₁₋ᵢ. For example, gateway 802 may transmit 803 the transaction request to at least one of receiving payment interface nodes 804₁₋ᵢ. Generally, a payment is generally redirected to the interface 804₁-804ᵢ closest to the payment gateway 802. In several aspects, gateway 802 selects the payment interface based on at least one of its latency, network traffic status, or geographical proximity. For example, a VISA™ payment interface node 804₁ receives the transmitted 803 request 801 from payment gateway 802 once it is selected by it based on at least one selection factor.

Generally a payment interface 804₁₋ᵢ sends the received transaction for processing by a node or group of nodes. However, rather than sending this transaction request 801 randomly to any group of nodes for processing, payment interface node 804₁ makes a call to the correlation function that it has already received, similar to FIG. 4 for example, and via the correlation function can identify or determine the node or the group that should process this transaction. Payment interface node can identify a node group 807ᵢ of the plurality of node groups 807₁₋ᵢ to serve the transaction request based on a correlation function.

Payment interface node 804₁ may identify the node or group that should process this transaction by executing the correlation function. Similar to method 700, the function may be executed to determine, by the payment interface, for example interface 804₁, based on a status of the payment interface 804₁, the status of the plurality of node groups 807₁₋ᵢ in the distributed cluster 810. Payment interface node 804₁ can then determine a local state, based on at least one of: the status of the payment interface 804₁, the status of the plurality of node groups 807₁₋ᵢ, a number of nodes in the distributed cluster 810, or a total number of nodes in the real-time payment interface system 800 (this latter group can for example include any or all nodes in the system including any payment interface nodes 804₁₋ᵢ and/or gateways). Finally, once payment interface node 804₁ determines the local state it may then calculate, based on the local state and a plurality of inputs, a target response that identifies the at least one node group 807₁₋ᵢ serve the request, for example node group 807₂. Once interface 804₁ determines the node or group to receive the request, it then transfers/redirects this request to a designate node 806 of that group 807₂.

The nodes in distributed cluster 810 may be organized in groups 807₁₋ᵢ. Each of the groups 807₁₋ᵢ may include one node that is a group designate. The group designate can comprise an exposed end point which receives requests for processing by the nodes that are part of its group. For example, group 807₂ comprises a group designate 806 (also referred to as a “group designate node”), and comprises nodes 809₁-809₃ to undertake the processing of a request 801. Group designate 806 upon receiving request 801, instead of randomly sending request 801 to any node 809₁₋₃ in its group 807₂, and on behalf of the group, calls the correlation function to find out which node 809₁-809₃ in the group 807₂ should act as the service node and process this transaction. For example, group designate 806 may identify node 809₁ as the service node and transmit 808 the request 801 to it for processing.

In several aspects, the identifying by the group designate 806 may be based on method 700, FIG. 7 and comprise determining, based on a status of the group designate node 806, the status of other nodes 809₁₋₃ in the node group 807₂. The group designate node may then determine a local state, based on at least one of the status of the group designate node 806, the status of the other nodes 809₁₋₃, a number of nodes in the node group 807₂, a total number of nodes in the distributed cluster 810, or a total number of nodes in the real-time payment interface system 800. Finally the group designate 806 can calculate, based on the local state and a plurality of inputs, a target response that identifies the at least one service node, for example node 809₁, in node group 807₂.

In several aspects, service node 809₁ services or processes request 801 and stores the result of the transaction in its local storage, cache, or in another storage of the node 809₁. In many aspects, the storage of all the 809₁₋₃ in the group 807₂ will be read and the processing details will be fed to a data-warehouse for further use and synchronization with other repositories, databases, or records.

FIG. 8B describes a substitute transaction, reverse, or substitute payment transaction being undertaken by a system 800, altering, substituting, or reversing the transaction that was illustrated in FIG. 8A. Payment reversal can be described as a scenario where after a transaction has gone through, a request to reverse that transaction is received either from the cardholder or the issuing bank. In traditional systems, settlement of reversal requests can take few days since the original processed transaction request, for example request 801, will first have to reflect in the central data repository, and only then can a reversal or substitute request be initiated.

However, the technologies described herein provide methods and systems for near-immediate and/or near-real time substitutions or reversals of transactions. This is because the service node that processed the request can be identified quickly by using a correlation function without having to flood the entire system 800 or distributed cluster 810 with broadcast messages. In traditional systems, at least two broadcasts are required within the system to quickly reverse a processed transaction, one broadcast message from the interface node that transmitted the request to the group of nodes, for example payment interface node 804₁, and a second broadcast message from the group designate, for example group designate 806, to identify which node in which group processed the original transaction. This flooding of the network with broadcast message can result in significant delay and network congestion and is therefore not feasible at a scalable level in traditional systems.

FIG. 8B provides an example of a much faster and smaller communication overhead transaction substitution technique. In this example, a request 811 for a substitute transaction, such as a payment reversal, refund or alteration, is received as soon as the payment was made and processed by the system 800. Once service node 809₁, completed processing the request 801, it stored it in its local storage or memory. The transaction has not yet synced with a central database or repository before the request for a substitute transaction was received by system 800. To successfully substitute or reverse processed transaction 801, node 809₁ has to be identified as the service node of the transaction 801. This will allow system 800 to reverse the transaction locally on the local storage of the service node (or on a local group storage of the group of the service node if the transaction was stored there), in this instance node 809₁.

Similar to the methodology in FIG. 8A, system 800 must determine a specific node. However, in contrast to the initial process in FIG. 8A where a node was identified to process a request, in this instance a node that processed request 801 at time=t, is identified by system 800 at time=t+1. The systems and methods discussed in relation to system 500, FIG. 5A-5B can be utilized in system 800 FIG. 8A-8B. Once a substitute transaction request 811 is initiated, by a bank, acquirer, issuer, merchant, or a client, then payment gateway 802 receives it. Gateway 802 directs transaction request 811 to a transaction interface of the plurality of interfaces 804₁₋ᵢ. For example, gateway 802 may transmit 812 transaction request 811 to at least one of receiving payment interface nodes 804₁₋ᵢ. Generally, a payment is generally redirected to the interface 804₁₋ᵢ closest to the payment gateway 802. In several aspects, gateway 802 selects the payment interface based on at least one of its latency, network traffic status, or geographical proximity. In this example, payment interface node 804₂ receives the transmitted 803 request 811 from payment gateway 802 once the payment interface is selected by gateway 802 based on one or more selection factors.

Generally a payment interface 804₁₋ᵢ sends the received transaction for processing by a node or group of nodes. However, rather than sending this transaction request 811 randomly to any group of nodes for processing, payment interface node 804₂ makes a call to the correlation function, and via the correlation function can identify or determine the node or the group that should process this transaction. IN this instance it is determining the node or group of nodes that services transaction 801 and possesses the data for that transaction in order to substitute, reverse, or alter it. Similar to payment interface 804₁ in FIG. 8A determining a group designate node or a node group to process or service the request 801, payment interface node 804₂ can identify a node group 807ᵢ of the plurality of node groups 807₁₋ᵢ that previously were selected by system 800 at time=t to serve the transaction request based on the same correlation function. The identifying by payment interface node 804₂ is undertaken by using the correlation function in a similar manner to the identifying undertaken by payment interface node 804₁ in FIG. 8A, but with parameters to calculate what would have been selected by payment interface node 804₁ at time=t.

Once payment interface 804₂ determines the node or group that previously would have received the transaction request 801 for processing, it then transfers/redirects substitute request 811 request to designate node 806 of identified group 807₂. In this example, the correlation function executed by payment interface 804₂ could be composed of the following: Function(transaction_reference_id, card_acceptor_id, retrieval_reference_number, card_number, amount, mcc, num_nodes, status_nodes)−>target response, where transaction reference id is an ID to uniquely identify the transaction. card acceptor id may for example be a unique identifier of the Point-of-Sale terminal where the card is swiped. The retrieval _reference_number can be a unique identification of a transaction for a specific POS terminal. The parameter card number may be an ID of the card that is swiped. The parameter amount may be related to a transaction amount. While mcc may comprise a Merchant Category Code (e.g., Airlines, Hotels, Retail etc.).

Once group designate 806 receives request 811, it proceeds to identify which node of nodes 809₁₋₃ in its group 807₂, serviced the last request 801, and possesses the processed data so that it may transmit 814 substitute or payment reversal request 811 to it for processing. The identifying is done in a similar manner as described related to FIG. 8A, by calling the correlation function to find out which node 809₁₋₃ in group 807₂ acts as the service node at time=t. Once it does this it identifies node 809₁ and transmits the request to it to be processed and substitute transaction request 801 with transaction request 811, for example by canceling a payment of request 801, or modifying the payment amount of request 801 with that of request 811. Transaction data or transaction amounts may all be altered or modified with the systems and methods described herein by utilizing a substitute transaction request 811 after an original transaction request 801 that has already been processed.

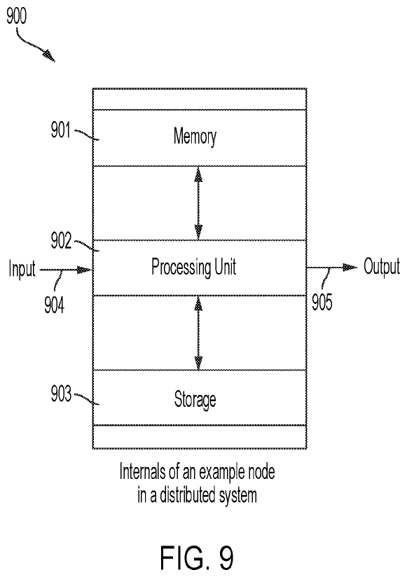

FIG. 9 illustrates an example node that may be used in a low communication node cluster in a distributed system, according to at least one aspect of the present disclosure. Node 900 may be any type of hardware device, or software module, a virtual machine for example, that forms part of a cluster, for example cluster 400, FIG. 4. Node 900 may also be a computer apparatus, for example computer apparatus 3000, FIG. 3. The node may also be a simplified node or node module 900. Node 900 my comprise a memory 901 for storing data or instructions, a processing unit 902 that can be comprised of one or more processors to execute instructions that may be stored on memory 901, and a storage 903 for storing data. The node may receive an input 904 such as an instruction, request, or a correlation function to install, load, or execute, and produce an output 905, which can be of any type or result such as a result of a correlation function, a request, transmission, message, communication, or instruction to another node or part of any of the systems discussed herein.

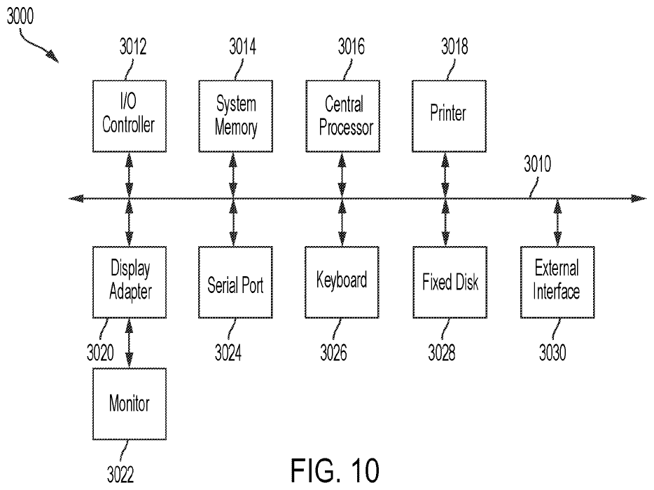

FIG. 10 is a block diagram of a computer apparatus 3000 with data processing subsystems or components, which a set of instructions to perform any one or more of the methodologies discussed herein may be executed, according to at least one aspect of the present disclosure. The subsystems shown in FIG. 10 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

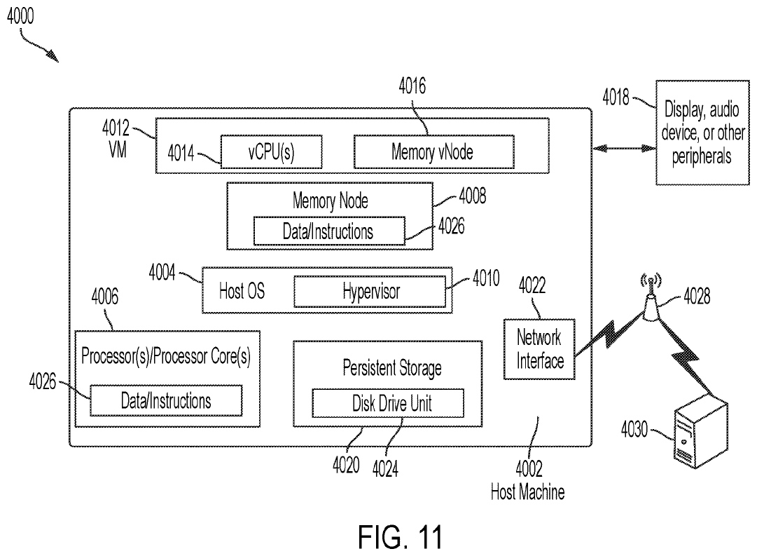

FIG. 11 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 3002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A method for reducing communications between nodes in a distributed system, the method comprising receiving, by each node in a distributed system, a correlation function with a plurality of inputs comprising at least an identifier; receiving, at a node of the distributed system, a request comprising the identifier; identifying, by the node, a service node to serve the request based on the correlation function, the identifying comprising determining, by the node, based on a status of the node, the status of other nodes in the distributed system; determining a local state, based on at least one of the status of the node, the status of the other nodes, or a number of nodes in the distributed system; and calculating, based on the local state and the plurality of inputs, a target response that identifies the service node; and processing the request by the service node.

Clause 2. The method of Clause 1, further comprising transmitting, by the node, the request to the service node.

Clause 3. The method of any one of Clauses 1-2, further comprising receiving, by the service node, the request transmitted from the node.

Clause 4. The method of any one of Clauses 1-3, further comprising receiving, by the node, a transmitted request from another node in the distributed system for processing, wherein the another node identified the node as the service node; and processing, by the node, the transmitted request.

Clause 5. The method of any one of Clauses 1-4, wherein the node is the service node.

Clause 6. The method of any one of Clauses 1-5, wherein the correlation function is configured to generate a mutually exclusive output based on the plurality of inputs.

Clause 7. The method of any one of Clauses 1-6, wherein the correlation function produces a mutually exclusive output to allow each node in the distributed system of nodes to determine a service node of the request.

Clause 8. The method of any one of Clauses 1-7, wherein the determining of a local state is based on the status of the node, the status of the other nodes, and the number of nodes in the distributed system.

Clause 9. A real-time financial transaction interface and processing system comprising a distributed cluster, connected to a plurality of payment interfaces, the distributed cluster comprising a plurality of node groups to process transaction requests, the plurality of node groups each comprising at least one node; a transaction gateway capable of interfacing with a plurality of client devices, configured to receive a transaction request from a client device; and direct the transaction request to a payment interface of the plurality of payment interfaces; the plurality of payment interfaces connected to the transaction gateway, wherein the payment interface of the plurality of payment interfaces is configured to receive the transaction request from the transaction gateway; identify a node group of the plurality of node groups to serve the transaction request based on a correlation function; and transmit the transaction request to a group designate node of the node group; the group designate node configured to identify at least one service node in the node group to serve the transaction request based on a correlation function; and transmit the transaction request to the at least one service node to process the transaction request.

Clause 10. The system of Clause 9, wherein the at least one service node stores a result of a processing of the transaction request in a local storage.

Clause 11. The system of any one of Clauses 9-10, wherein the stored result is transmitted into a data storage warehouse.

Clause 12. The system of any one of Clauses 9-11, wherein the at least one service node is configured to: receive a substitute transaction request for a processed transaction stored in its local storage; and process the substitute transaction request to alter

Clause 13. The system of any one of Clauses 9-12, wherein the transaction gateway is further configured to select the payment interface based on at least one of its latency, network traffic status, or geographical proximity.

Clause 14. The system of any one of Clauses 9-13, wherein the identifying of the node group by the payment interface comprises determine, by the payment interface, based on a status of the payment interface, the status of the plurality of node groups in the distributed cluster; determine a local state, based on at least one of the status of the payment interface, the status of the plurality of node groups, or a number of nodes in the distributed cluster, or a total number of nodes in the real-time financial transaction interface and processing system; and calculate, based on the local state and a plurality of inputs, a target response that identifies at least one of the plurality of node groups.

Clause 15. The system of any one of Clauses 9-14, wherein each node group of the plurality of node groups comprises an exposed end point, the exposed end point configured to receive the transaction request to be processed by the at least one node in the node group; and undertake the identifying of the at least one service node for the node group.

Clause 16. The system of any one of Clauses 9-15, wherein the identifying of the at least one service node by the group designate node comprises determine, based on a status of the group designate node, the status of other nodes in the node group; determine a local state, based on at least one of the status of the group designate node, the status of the other nodes, a number of nodes in the node group, a total number of nodes in the distributed cluster, or a total number of nodes in the real-time financial transaction interface and processing system; and calculate, based on the local state and a plurality of inputs, a target response that identifies the at least one service node.

Clause 17. The system of any one of Clauses 9-16, wherein the transaction request is at least one of a payment request, or a payment-reversal request.

Clause 18. A non-transitory machine readable medium storing code, which when executed by a processor is configured to receive, a correlation function with a plurality of inputs comprising at least an identifier; receive, a request comprising the identifier; identify, a service node to serve the request based on the correlation function, the identifying comprising determine, based on a status of one node, the status of other nodes in a distributed system; determine a local state, based on at least one of the status of the node, the status of the other nodes, or a number of nodes in the distributed system; and calculate, based on the local state and the plurality of inputs, a target response that identifies the service node.

Clause 19. The non-transitory machine readable medium storing code of Clause 18, which when executed by a processor is further configured to transmit the request to the service node.

Clause 20. The non-transitory machine readable medium of any one of Clauses 18-19, wherein the determining of the local state is based on at least one of the status of the node, the status of the other nodes, or a number of nodes in a distributed system.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A method for reducing communications between nodes in a distributed system, the method comprising:
receiving, by each node in a distributed system, a correlation function with a plurality of inputs comprising at least an identifier;
receiving, at a node of the distributed system, a request comprising the identifier;
identifying, by the node, a service node to serve the request based on the correlation function, the identifying comprising:
determining, by the node, based on a status of the node, the status of other nodes in the distributed system;
determining a local state, based on at least one of the status of the node, the status of the other nodes, or a number of nodes in the distributed system; and
calculating, based on the local state and the plurality of inputs, a target response that identifies the service node; and
processing the request by the service node.

2. The method of claim 1, further comprising:
transmitting, by the node, the request to the service node.

3. The method of claim 2, further comprising:
receiving, by the service node, the request transmitted from the node.

4. The method of claim 1, further comprising:
receiving, by the node, a transmitted request from another node in the distributed system for processing, wherein the another node identified the node as the service node; and
processing, by the node, the transmitted request.

5. The method of claim 1, wherein the node is the service node.

6. The method of claim 1, wherein the correlation function is configured to generate a mutually exclusive output based on the plurality of inputs.

7. The method of claim 1, wherein the correlation function produces a mutually exclusive output to allow each node in the distributed system of nodes to determine a service node of the request.

8. The method of claim 1, wherein the determining of a local state is based on the status of the node, the status of the other nodes, and the number of nodes in the distributed system.

9. A real-time financial transaction interface and processing system comprising:
a distributed cluster, connected to a plurality of payment interfaces, the distributed cluster comprising a plurality of node groups to process transaction requests, the plurality of node groups each comprising at least one node;
a transaction gateway capable of interfacing with a plurality of client devices, configured to:
receive a transaction request from a client device; and
direct the transaction request to a payment interface of the plurality of payment interfaces;
the plurality of payment interfaces connected to the transaction gateway, wherein the payment interface of the plurality of payment interfaces is configured to:
receive the transaction request from the transaction gateway;
identify a node group of the plurality of node groups to serve the transaction request based on a correlation function; and
transmit the transaction request to a group designate node of the node group;
the group designate node configured to:
identify at least one service node in the node group to serve the transaction request based on a correlation function; and
transmit the transaction request to the at least one service node to process the transaction request.

10. The system of claim 9, wherein the at least one service node stores a result of a processing of the transaction request in a local storage.

11. The system of claim 10, wherein the stored result is transmitted into a data storage warehouse.

12. The system of claim 9, wherein the at least one service node is configured to:
receive a substitute transaction request for a processed transaction stored in its local storage; and
process the substitute transaction request to alter the processed transaction.

13. The system of claim 9, wherein the transaction gateway is further configured to:
select the payment interface based on at least one of its latency, network traffic status, or geographical proximity. (Original) The system of claim 9, wherein the identifying of the node group by the payment interface comprises:
determine, by the payment interface, based on a status of the payment interface, the status of the plurality of node groups in the distributed cluster;
determine a local state, based on at least one of the status of the payment interface, the status of the plurality of node groups, or a number of nodes in the distributed cluster, or a total number of nodes in the real-time financial transaction interface and processing system; and
calculate, based on the local state and a plurality of inputs, a target response that identifies at least one of the plurality of node groups.

15. The system of claim 9, wherein each node group of the plurality of node groups comprises an exposed end point, the exposed end point configured to:
receive the transaction request to be processed by the at least one node in the node group; and
undertake the identifying of the at least one service node for the node group.

16. The system of claim 9, wherein the identifying of the at least one service node by the group designate node comprises:
determine, based on a status of the group designate node, the status of other nodes in the node group;
determine a local state, based on at least one of the status of the group designate node, the status of the other nodes, a number of nodes in the node group, a total number of nodes in the distributed cluster, or a total number of nodes in the real-time financial transaction interface and processing system; and
calculate, based on the local state and a plurality of inputs, a target response that identifies the at least one service node.

17. The system of claim 9, wherein the transaction request is at least one of a payment request, or a payment-reversal request.

18. A non-transitory machine readable medium storing code, which when executed by a processor is configured to:
receive, a correlation function with a plurality of inputs comprising at least an identifier;
receive, a request comprising the identifier,
identify, a service node to serve the request based on the correlation function, the identifying comprising:
determine, based on a status of one node, the status of other nodes in a distributed system;
determine a local state, based on at least one of the status of the node, the status of the other nodes, or a number of nodes in the distributed system; and
calculate, based on the local state and the plurality of inputs, a target response that identifies the service node.

19. The non-transitory machine readable medium storing code of claim 18, which when executed by a processor is further configured to:
transmit the request to the service node.

20. The non-transitory machine readable medium of claim 18, wherein the determining of the local state is based on at least one of the status of the node, the status of the other nodes, or a number of nodes in a distributed system.
